(19) United States
(12) Patent Application Publication
(10) Pub. No.: US 2002/0065920 A1
(43) Pub. Date: May 30, 2002

(54) Host site based internet traffic meter

(76) Inventors: Brian M. Siegel, Washingtonville, NJ (US); Greg Gudorf, San Diego, CA (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/726,973

(22) Filed: Nov. 30, 2000

(51) Int. Cl. G06F 15/16; G06F 15/173

(52) U.S. Cl. 709/227; 709/203; 709/224; 707/513

(57) ABSTRACT

A method of personalizing information presented at a host web site includes obtaining personal data about a user during a visit to the host web site, and after obtaining the personal data, monitoring the content of other web sites visited by the user. During subsequent visits by the user to the host web site, the content of the information presented by the host web site to the user is personalized so that the content of the information is related to the content of the other web sites visited by the user and/or the personal data obtained for the user.

### BACKGROUND OF THE INVENTION

The present invention relates methods of providing information over the Internet and more particularly relates to providing a user with a personalized Internet experience responsive to the user's interests and background.

On the Internet, information presented to users may be targeted in a more discriminating manner than is possible with other media such as newspaper and television. As a result, advertisers can target specific consumers with great precision. For example, there is a high probability that users visiting travel-related web sites may be interested in contacting travel agents. Thus, a travel agent placing a directed advertisement on a travel-related web site may reach a smaller group of people than when using newspaper and television, however, a much higher percentage of this group will be potential customers.

In order to take advantage of the ability to reach certain consumers on the Internet, advertisers frequently profile users in order to estimate a user's interest in a particular product. These profiling techniques are often used to help an advertiser select a particular advertisement to be presented to a user. There presently exist many different profiling techniques including using hypertext transfer protocol (HTTP) information, digital identification, geographic information and demographic information.

One effort to profile Internet users is disclosed in U.S. Pat. No. 6,044,376 to Kurtzman which teaches a content stream analysis system that generates a user profile based upon the contents of files selected and viewed by a user. This user profile is then used to select advertisements that are presented to the user over the Internet.

U.S. Pat. No. 6,009,410 to LeMole et al. discloses a system that presents customized advertisements to users on the Internet. In LeMole, a customized advertising repository server is connected on the Internet, and can be accessed by a registered user through his or her browser, either by clicking on an icon or by inputting a specific URL address of the server storing that user's advertising repository. When the user accesses his or her Customized Advertising Repository (CAR), a composite advertising page is dynamically configured by the CAR server for that particular user based on that user's previously provided user profile. Furthermore, at least a portion of the composite advertising page can be dynamically configured based upon the particular web site or sites that the user has accessed prior to accessing the CAR. The composite page is configured from a database that stores images, banners, animations, etc. from a wide variety of advertisers.

### SUMMARY OF THE INVENTION

In accordance with certain preferred embodiments of the present invention, a method of personalizing information presented to a user at a host web site includes obtaining personal data about a user during a visit to the host web site and, after obtaining the personal data, monitoring the content of other web sites visited by the user. During a subsequent visit to the host web site, the information presented to the user is personalized so that the content of the information presented to the user during the subsequent visit is related to the content of the other web sites visited by the user and/or personal demographic data obtained from the user.

In one particular preferred embodiment, a user will visit a host web site, such as the web site having the domain name SONYSTYLE.COM, owned and operated by Sony Electronics of America. At the host web site, the user will be queried as to whether he or she wishes to complete a personal data registration form so as to register with the host web site. The request for personal data will be explicit, and the user will be informed that the personal data will be used to monitor the user's subsequent activities on the Internet. The user's activities are tracked so that the host web site may gather information about the user's interests and preferences. As a result, when the user returns to the host web site at a future date, the content of the information displayed to the user will be modified so that the content of the information substantially matches the user's interests and/or personal demographic data. If the user declines to complete the personal data registration form, then the user may continue to review the material presented by the host web site. In this particular scenario, the host web site will not compile personal and/or demographic information about the user or the user's web surfing preferences.

If the user does complete the personal data registration form, then the host web site will transmit a cookie to the user's hardware. The cookie may be stored in the user's hard drive. The user will then complete the personal data registration form that preferably includes information such as the user's name, address, zip code, telephone number, e-mail address, age and occupation. As the user completes the personal data registration form, the personal data will be recorded on the user's cookie. The data recorded on the cookie will be transmitted to the host web site. The cookie information including the personal data is preferably recorded in one or more databases maintained by the host web site so that the information can be retrieved and updated each time a user access the host web site. Upon receiving the personal data, the host web site will process the information and store it in a database. In certain preferred embodiments, each user may be indexed by one or more components of the personal data (e.g. by last name or social security number).

In certain preferred embodiments, a user may be assigned a unique identity that is linked to the personal computer (PC) used to access the host web site. For example, a user may visit business related web sites from a first PC at work and entertainment related sites from a second PC at home. The host web site of the present invention desirably assigns a first cookie to the user's work PC and a second cookie to the user's home PC. The cookie assigned to the work PC will track and monitor the web sites that the user visits at work. This information will be stored in a database maintained by the server of the host web site. The cookie assigned to the home PC will track and monitor the web sites that the user visits at home. This information will also be stored by the server of the host web site. The information stored about usage of the work PC will have a different content than the information stored on usage of the home PC. As a result, the user's experience when visiting the host web site may be very different depending upon which PC is utilized to visit the host web site.

By completing the personal data registration form, the user agrees that his subsequent web surfing activities may be monitored, recorded and stored on the user's cookie. As a result, the user's web surfing preferences (i.e., interests) will be recorded on the cookie and transmitted to the host web site at a later time. In one embodiment, the user's Internet surfing history is transmitted to the host web site each time the user's computer is turned on. In other embodiments, the user's web surfing information is transmitted to the host web site each time the user returns to the host web site.

When the user returns to the host web site, the host web site will retrieve information from the user's cookie so as to identify the identity of the user. The host web site will then compare the information retrieved from the cookie with any information previously stored at the host web site. The host web site will then update its profile for the user, if necessary, including any subsequent web surfing activities recorded on the user's cookie. As used herein, the term “user profile” means the user's interests and preferences as expressed by the user when surfing the Internet, and may also include personal demographic data for the user such as name, age, occupation, and income. The host server supporting the web site may also record any changes in the user's personal data. The personal data and updated user interest profile will then be used to compile a personalized web page that reflects the user's interests and/or personal data. In other words, the content of the information presented to the user at the host web site will be modified in response to the user's interests or personal data. As a result, the host web site will transmit a web page to a user that has been modified to reflect the user's interests. Such personalized web pages will greatly enhance the user's visit to the host web site, thereby making the visit more profitable for both the user and the company/entity hosting the web site.

In still other preferred embodiments of the present invention, a method of personalizing information presented to a user of a host web site includes collecting identifying data about the user during a first visit to the host web site, and after collecting the identifying data, monitoring the subject matter content of other web sites visited by the user, and during a subsequent visit by the user to the host web site, personalizing the information presented to the user based upon the identifying data collected from the user and the subject matter content of the other web sites visited by the user.

These and other preferred embodiments of the present invention will be described in more detail below.

### BRIEF DESCRIPTION OF THE DRAWINGS

FIG. 1 is a block diagram of a communications system in which a user is connected to a host web site through the Internet, in accordance with certain preferred embodiments of the present invention.

FIG. 2 is a flow chart showing preferred steps for personalizing a host web site for a user, in accordance with certain preferred embodiments of the present invention.

FIG. 3 shows a personal data registration form which is downloaded to a user's terminal by the host web site, in accordance with certain preferred embodiments of the present invention.

### DETAILED DESCRIPTION OF PREFERRED EMBODIMENTS

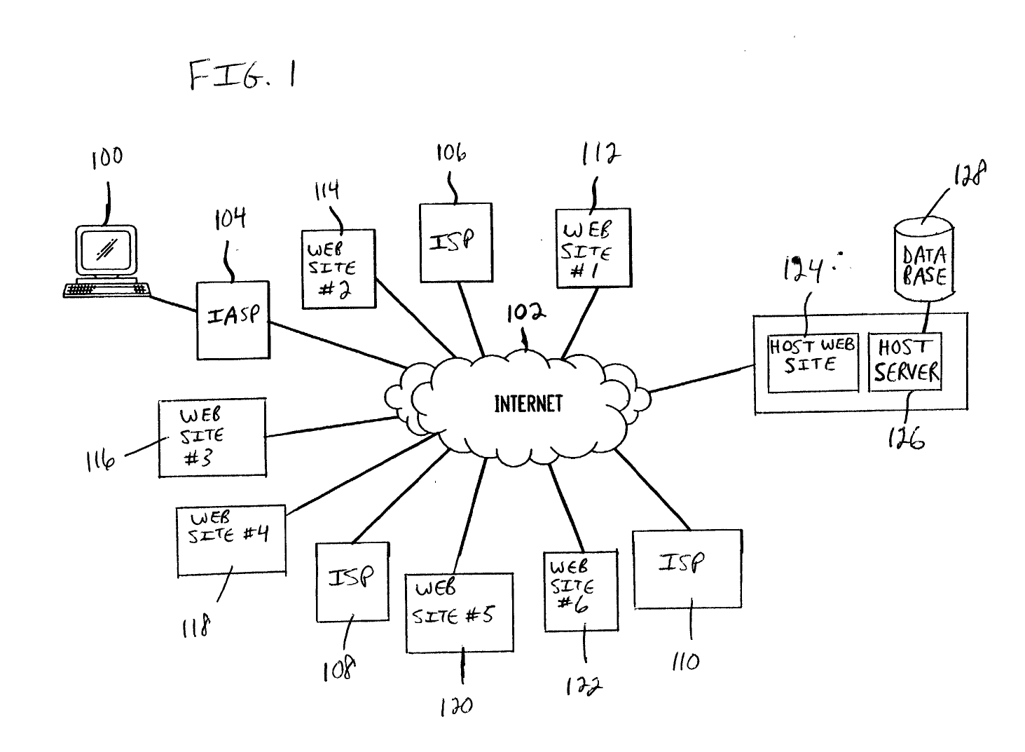

Referring to FIG. 1, a user at a user-end terminal 100 is connected to the Internet 102 via an Internet Access Service Provider (IASP) 104. The user-end terminal 100 may be a personal computer, a laptop computer, wireless phones, pagers, personal digital assistants and/or set top boxes such as those sold under the trademark TIVO. The connection of user-end terminal 100 to ISAP 104 and Internet 102 may be made in a wide variety of ways including modem, ISDN lines, cable modem over cable television transmission facilities, land-lines, satellite, and/or wireless facilities.

By using Internet 102, a user is able to obtain access to a wide variety of web sites, such as by specifying the URL address of a desired web site or by conducting a key word search. A browser within the user-end terminal 100 sends a request over the Internet 102 to an identified Internet Service Provider (ISP) for that specific page. The requested page, as identified by the user-inputted URL address, is in turn transmitted back over the Internet 102 through IASP 104 to user-end terminal 100 for display on the user's terminal. By subsequently inputting a series of URL addresses manually through the browser or by clicking the user-end terminal's mouse on a hyperlink, or through a combination of both, the user is able to navigate through a wide variety of URL addressed pages of information at ISP 106 and any of the other ISPs, such as ISPs 108 and 110, connected to the Internet 102. Thus, a user may “surf the Net” in order to receive information, make on-line purchases and/or access on-line services.

While surfing the Net, the user may visit a number of different web sites 112, 114, 116, 118, 120 and 122, such web sites being designated web sites # 1-6. The user may also visit a host web site 124 including server 126 and a database 128 for storing information. As will be described in more detail below, the host web site 124 preferably stores personal data related to one or more users in database 128. The personal data may serve as an index for retrieving a profile on each user. The profile will preferably include information related to the user's interests, likes and preferences, such information being gathered by monitoring the user's Internet activities. Each time a user revisits the host web site 124, the host server 126 will operate to retrieve any new information available on the profiled user. As a result, the material transmitted by the host web site to the user at the user-end terminal 100 may be personalized and/or modified so that the material presented to the user is related to the user's Internet interests.

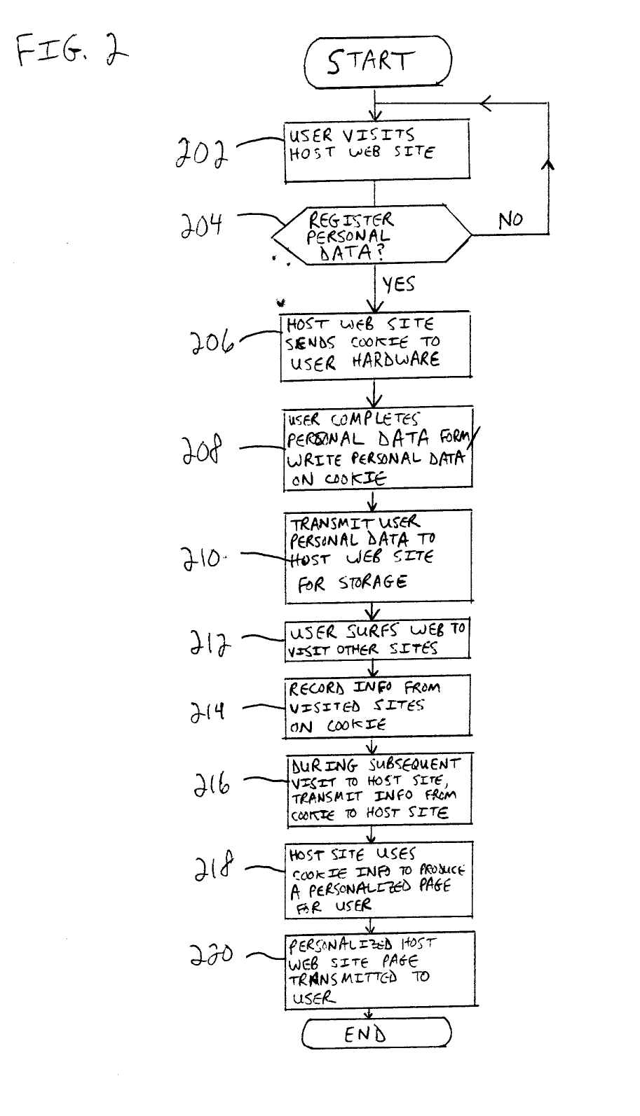

Referring to FIG. 2, in accordance with one preferred embodiment of the present invention, a user visits a host web site 124 (FIG. 1) at step 202. The host web site may provide a wide variety of information, such as the Internet web site having the URL SONYSTYLE.COM, owned and operated by Sony Electronics of America. At step 204, the user will be queried as to whether he or she wishes to register personal data to be stored by the host web site. Unlike prior art methods that obtain identifying information about a user without the user's knowledge or consent, the present invention will only seek to obtain information about the user if the user fully understands and authorizes such action.

If the user agrees to register personal data with the host web site, the host web site transmits a cookie via the Internet to the user's hardware. As used herein, the term “cookie” means information that a web site stores on a user's hard disk so that the web site can identify the user and/or retrieve information about the user at a later time. In other words, a cookie is information for future use that is stored by a server on the client's side of a client/server communication. Cookies are commonly used to rotate banner ads that a web site sends to a user so that the web site does not keep sending the same ad to the user. Cookies may also be used to customized pages for a user based the user's browser type or other information that may have been provided to the web site.

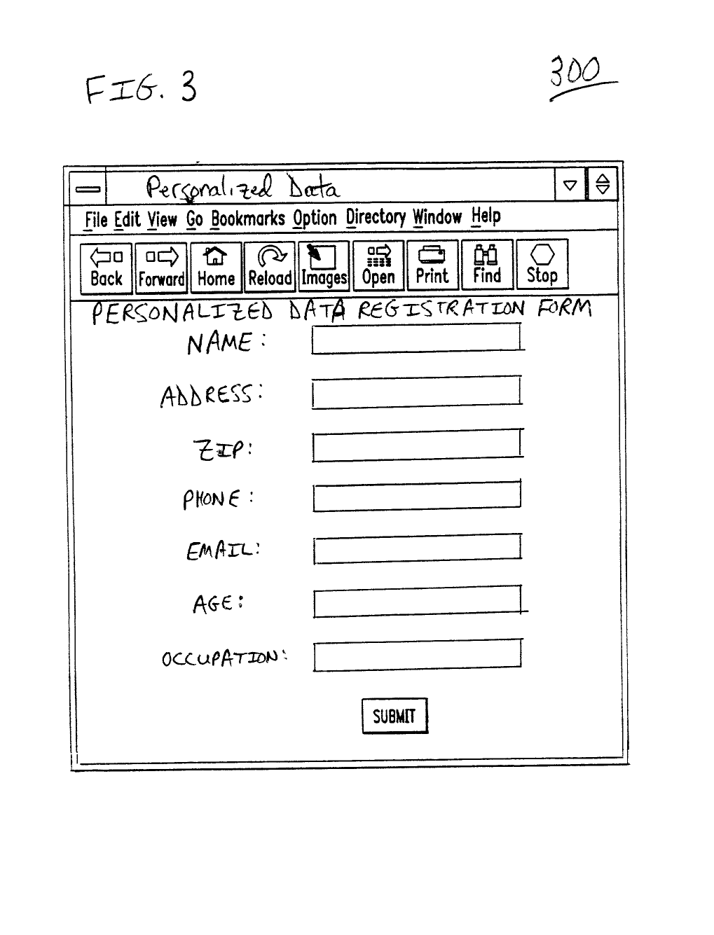

If the user agrees to register personal data with the host web site, and after receiving the cookie from the host web site, the user must complete a personal data registration form at step 208. Referring to FIG. 3, one preferred personalized data registration form 300 is shown therein. Personalized data form 300 includes areas for entering the user's name, address, zip, phone number, email address, age and occupation. However, preferred personalized data registration forms may also include other types of information commonly used to identify individuals, such as social security numbers or taxpayer identification codes.

After the personal data registration form has been completed, the information entered on the form by the user will be written onto the user's cookie at step 208. The personal data may then be transmitted to the host web site for storage in the database 128 of the host web site 124 (FIG. 1).

At step 212, the user “surfs the Net” by visiting other web sites. As used herein the terminology “surfs the Net” or “surfing the Net” means accessing web pages from various servers using the Internet. The other web sites or follow-on web sites may be accessed by typing the URLs for the various web sites into the hyper-text transfer protocol portion (HTTP) of a web page or by using a mouse to click on the hypertext links appearing on a web page. At step 214, the information related to the various web sites visited by the user is recorded in the user's cookie. At step 216, the user once again visits the host web site. At this time, the personal data stored in the user's cookie is transmitted to the host web site. The personal data of the user is used as an index for gaining access to the user's preference profile stored in database 128. Next, the user's content preferences stored in the cookie are compared to the user's profile previously stored in the database. If there are any differences between the information stored in the cookie and the information stored in the host web site database, the host web site database will be updated so as to reflect the new and/or changed information.

At step 218, the host web site uses the user's personal data and the updated preference profile to produce a personalized web page for a user. For example, if the user frequently accesses family-targeted web sites, then the host web site will transmit a family-targeted web site page to the user the next time the user visits the host web site. The personalized web site page is transmitted to the user-end terminal at step 220. Thus, at least one segment of the user's personal data will be used to provide an index for the user. In addition to serving as an index, the personal data may also be used to personalize the content of the web page presented to the user. For example, a teenager may receive a personalized web page that promotes electronics that may be used in an “active environment” such as the beach. However, if the user is a senior citizen, the host web site may modify the web page transmitted to the user to promote radios that may be used in a sedentary environment such as a golf course.

Although the present invention has been described with reference to particular embodiments, it is to be understood that the embodiments are merely illustrative of the principles and applications of the present invention. It is therefore to be understood that numerous modifications may be made to the illustrative embodiments and that other arrangements may be devised without departing from the spirit and scope of the present invention as defined by the claims.

1. A method of personalizing information presented at a host web site comprising:
obtaining personal data about a user during a visit to the host web site;
after obtaining the personal data, monitoring the content of other web sites visited by the user; and
during a subsequent visit by the user to the host web site, personalizing the information presented to the user, wherein the content of the information presented to the user during the subsequent visit to the host web site is related to the content of the other web sites visited by the user.

2. The method as claimed in claim 1, wherein the content of the information presented to the user during the subsequent visit to the host web site is related to the personal data obtained from the user.

3. The method as claimed in claim 1, further comprising obtaining authorization from the user to monitor the other web sites visited by the user.

4. The method as claimed in claim 1, further comprising:
placing a cookie on a hard disk of the user; and
recording the personal data about the user and the content of the other web sites visited by the user on the cookie.

5. The method as claimed in claim 4, further comprising retrieving from the cookie the personal data of the user and the content of the other web sites visited by the user.

6. The method as claimed in claim 5, wherein the personal data of the user and the content of the other web sites visited by the user are retrieved from the cookie during each subsequent visit to the host web site.

7. The method as claimed in claim 2, further comprising continuously updating the content of the information presented to the user during each subsequent visit to the host web site, wherein the content of the information is updated in response to any changes in the personal data for the user or in the content of the other web sites visited by the user.

8. The method as claimed in claim 1, wherein the content of the other web sites visited by the user includes the URL addresses of the visited web sites.

9. The method as claimed in claim 1, wherein the content of the other web sites visited by the user includes the length of time spent viewing the other web sites.

10. The method as claimed in claim 1, wherein the content of the other web sites visited by the user includes the number of times the user visits each of the other web sites.

11. The method as claimed in claim 1, wherein the content of the other web sites visited by the user includes any applets that are downloaded from the other web sites visited by the user.

12. The method as claimed in claim 1, further comprising presenting the personalized information on a device selected from the group consisting of personal computers, a laptop computer, set top boxes, wireless phones, pagers and personal digital assistants.

13. The method as claimed in claim 1, wherein the personal data about the user includes any information used to identify the user as a unique individual.

14. The method as claimed in claim 13, wherein the personal data includes the user's name, address, zip code, occupation, phone number, education level, income, marital status, citizenship, home ownership status, age and health.

15. A method of personalizing information presented to a user of a host web site comprising:
collecting identifying data about the user during a first visit to the host web site;
after collecting the identifying data, monitoring the content of other web sites visited by the user; and
during a subsequent visit by the user to the host web site, personalizing the information presented to the user based upon the identifying data collected about the user and the content of the other web sites visited by the user.

16. The method as claimed in claim 15, further comprising:
placing a cookie on a hard drive of the user;
recording information related to the identifying data of the user and the content of the other web sites visited by the user on the cookie.

17. The method as claimed in claim 16, further comprising during each subsequent visit to the host web site, transferring the information recorded on the cookie to the host web site.

18. The method as claimed in claim 17, further comprising continuously updating the information recorded on the cookie.
